(19) United States
(12) Patent Application Publication
(10) Pub. No.: US 2008/0176128 A1
(43) Pub. Date: Jul. 24, 2008

(54) FUEL CELL

(75) Inventors: Ching-Po Lee, Hsinchu (TW); Jin-Shu Huang, Hsinchu (TW); Cheng Wang, Hsinchu (TW); Nien-Hui Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/923,648

(22) Filed: Oct. 24, 2007

(30) Foreign Application Priority Data
Jan. 19, 2007 (TW) 96102041

(51) Int. Cl. H01M 8/04; H01M 8/10

(52) U.S. Cl. 429/39; 429/30

(57) ABSTRACT

A fuel cell including a membrane electrode assembly (MEA), an anode current collector, a cathode current collector and a water transport layer is provided. The MEA includes an anode layer, a cathode layer, and an electrolyte layer disposed between the anode layer and the cathode layer. The anode current collector is in contact with the anode layer. The cathode current collector is in contact with the cathode layer to dispose the MEA between the anode current collector and the cathode current collector, and the cathode current collector has a plurality of first openings. The water transport layer is attached on the cathode current collector and includes a capillary material and a plurality of second openings corresponding to the first openings of the cathode current collector.

### CROSS-REFERENCE TO RELATED APPLICATION

This application claims the priority benefit of Taiwan application serial no. 96102041, filed on Jan. 19, 2007. All disclosure of the Taiwan application is incorporated herein by reference.

### BACKGROUND OF THE INVENTION

1. Field of the Invention

The present invention relates to a fuel cell. More particularly, the present invention relates to a fuel cell that uses a water transport layer to drain water accumulated in a cathode layer.

2. Description of Related Art

With the advancement of science and technology, more and more traditional energy sources, such as coal, petroleum, and natural gas, are consumed. Currently, due to the limited natural energy reserves, many countries are developing new substitute energy sources to replace the traditional ones, and among others, fuel cells are important choices with a practical value.

In brief, the fuel cell is basically a power generation device that converts chemical energy into electric energy through the inverse reaction of water electrolysis. At present, common fuel cells include phosphate fuel cells (PAFC), solid oxide fuel cells (SOFC), or proton exchange membrane fuel cells (PEMFC).

For example, the PEMFC mainly includes a membrane electrode assembly (MEA), an anode current collector, and a cathode current collector. The MEA mainly includes an anode layer, a cathode layer, and a proton exchange membrane disposed between the anode layer and the cathode layer. The anode current collector is in contact with the anode layer, and the cathode current collector is in contact with the cathode layer. The fuel (such as methanol or hydrogen gas) for the anode layer chemically reacts with a catalyst on the anode layer to generate hydrogen ions and electrons. The hydrogen ions penetrate the proton exchange membrane and reach the cathode layer, and the electrons reach the cathode layer through a circuit. Next, the hydrogen ions and the electrons chemically react with the catalyst on the cathode layer and the oxygen gas, and generate water. At this time, a current is formed with the flow of the electrons in the fuel cell.

It should be noted that, in the fuel cell, the MEA generates water on the cathode layer after the chemical reaction mentioned above. When the reactants of the anode layer are methanol and water, the water on the anode layer also penetrates the proton exchange membrane due to electro-osmotic drag to the cathode layer. However, if the water is accumulated on the cathode layer, the catalyst of the cathode layer may not come in contact with the oxygen gas smoothly, thereby degrading the power generating efficiency of the fuel cell.

Currently, for the common fuel cells, a fan or an air pump is often employed to drain the water accumulated on the cathode layer after the chemical reaction. The fan of the fuel cell not only provides the oxygen gas required by the chemical reaction to the cathode layer, but also may evaporate the water accumulated on the cathode layer by accelerating air convection. Further, when the fuel is methanol, the water vapor may further be reclaimed to the anode layer to be used again.

However, in order to evaporate the water, the rotational speed of the fan must be increased, so more electric energy generated by the fuel cell will be consumed. Furthermore, the increase of the rotational speed of the fan will accelerate the air convection and the evaporation of the water. However, since the reaction temperature of the fuel cell is usually higher than the normal temperature, but the air convection and the evaporation of the water will reduce the temperature of the fuel cell, the power generating efficiency of the fuel cell will be degraded. Furthermore, as for the method of evaporating the water through air convection, a part of the water accumulated on the cathode layer may not be drained due to a non-uniform air flow field caused by the air convection. Moreover, a part of vapor will not be condensed to be water, such that the water on the anode layer is not sufficient to be used again.

### SUMMARY OF THE INVENTION

The present invention is directed to a fuel cell, in which water generated on a cathode layer in a membrane electrode assembly (MEA) after a chemical reaction may be removed by capillary action without consuming additional energy generated by the fuel cell.

The present invention may be further understood from the technical features disclosed in the present invention.

As embodied and broadly described herein, the fuel cell provided by the present invention includes an MEA, an anode current collector, a cathode current collector, and a water transport layer. The MEA includes a cathode layer, an anode layer, and an electrolyte layer disposed between the anode layer and the cathode layer. The anode current collector is in contact with the anode layer. The cathode current collector is in contact with the cathode layer to dispose the MEA between the anode current collector and the cathode current collector, and the cathode current collector has a plurality of first openings. The water transport layer is attached on the cathode current collector, and includes a capillary material and a plurality of second openings corresponding to the first openings of the cathode current collector.

As embodied and broadly described herein, the present invention also provides a fuel cell including an MEA, an anode current collector, a cathode current collector, a cathode flow field plate, and a water transport layer. The MEA includes a cathode layer, an anode layer, and an electrolyte layer disposed between the cathode layer and the anode layer. The anode current collector is in contact with the anode layer. The cathode current collector is in contact with the cathode layer and has a plurality of first openings. The cathode flow field plate is in contact with the cathode current collector, and is disposed on one side of the MEA not facing the cathode current collector. The water transport layer is attached on the cathode flow field plate, and includes a capillary material.

As embodied and broadly described herein, the fuel cell further provided by the present invention includes an MEA, an anode current collector, and a cathode current collector. The MEA includes a cathode layer, an anode layer, and an electrolyte layer disposed between the cathode layer and the anode layer. The anode current collector is in contact with the anode layer. The cathode current collector is in contact with the cathode layer, and has a plurality of first openings and a water transport micro flow field.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic side view of a fuel cell according to a first embodiment of the present invention.

FIG. 2 is an exploded isometric view of the fuel cell in FIG. 1.

FIGS. 3A and 3B are schematic top views of the fuel cell according to a second embodiment of the present invention.

FIG. 4 is a schematic top view of the fuel cell according to a third embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### The First Embodiment

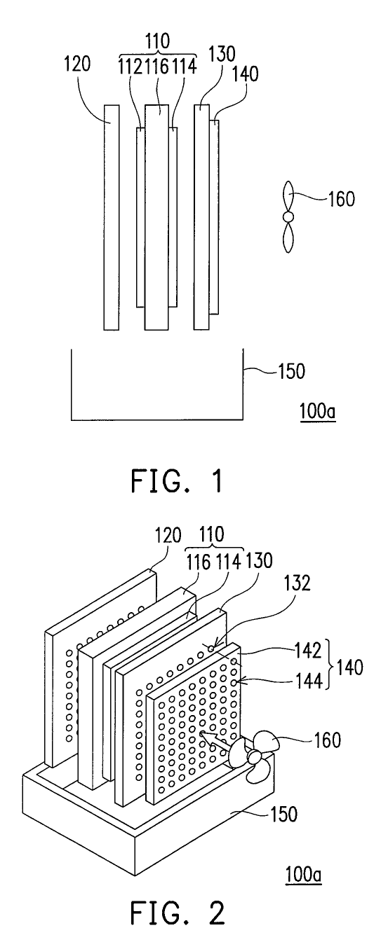

Referring to FIGS. 1 and 2, a fuel cell 100a of the first embodiment of the present invention includes an MEA 110, an anode current collector 120, a cathode current collector 130, and a water transport layer 140. The MEA 110 includes an anode layer 112, a cathode layer 114, and an electrolyte layer 116 disposed between the anode layer 112 and the cathode layer 114. The anode current collector 120 is in contact with the anode layer 112. The cathode current collector 130 is in contact with the cathode layer 114, and the MEA 110 is disposed between the anode current collector 120 and the cathode current collector 130. The cathode current collector 130 has a plurality of first openings 132. The water transport layer 140 is attached on the cathode current collector 130, and includes a capillary material 142 and a plurality of second openings 144 corresponding to the first openings 132 of the cathode current collector 130.

In this embodiment, the electrolyte layer 116 is, for example, a proton exchange membrane, the water transport layer 140 is, for example, fixed on the cathode current collector 130 by means of adhesion, riveting, or compression, and the capillary material 142 is formed of, for example, paper, gauze, cotton cloth, a fiber material or other capillary materials. Furthermore, the anode layer 112 includes, for example, an anode catalyst layer (not shown) and an anode gas diffusion layer (not shown), and the cathode layer 114 includes, for example, a cathode catalyst layer (not shown) and a cathode gas diffusion layer (not shown). Furthermore, the fuel cell 100a, for example, uses the catalyst layer in the MEA 110 to catalyze the fuel to chemically react to generate electric power for use. Furthermore, the fuel may be, for example, hydrogen gas or methanol.

In detail, the anode catalyst layer makes the fuel (such as methanol or hydrogen gas) on the anode layer 112 subject to chemical reaction to generate hydrogen ions and electrons. The hydrogen ions penetrate the anode gas diffusion layer, the electrolyte layer 116 and the cathode gas diffusion layer and reach the cathode catalyst layer; the electrons reach the cathode layer 114 through a circuit and generate current for use. Next, the cathode catalyst layer initiate a chemical reaction between the hydrogen ions and the electrons reaching the cathode layer 114, and the oxygen gas on the cathode layer 114 to generate water.

When the fuel is methanol and water, the reaction formula of the chemical reaction on the anode layer 112 is 2CH₃OH+2H₂O→2CO₂+12H₂+12e⁻, and the reaction equation of the chemical reaction on the cathode layer 114 is 12H⁺+12e⁻+3O₂→6H₂O. Furthermore, the total reaction formula of the fuel cell 100a is 2CH₃OH+3O₂→2CO₂+4H₂O. In addition, when the fuel is hydrogen gas, the reaction equation of the chemical reaction on the anode layer 112 is 2H₂→4H⁺+4e⁻, and the reaction equation of the chemical reaction on the cathode layer 114 is 4H⁺+4e⁻+O₂→2H₂O. Furthermore, the overall reaction equation of the fuel cell 100a is 2H₂+O₂→2H₂O.

It can be known from the aforementioned chemical formulae that regardless of whether the fuel of the fuel cell 100a is methanol or hydrogen gas, water will be generated on the cathode layer 114 of the MEA 110 after the chemical reaction. At this point, the water is absorbed by the capillary material 142 of the water transport layer 140, and is drained out of the capillary material 142 due to gravity action. In particular, the capillary material 142 of the water transport layer 140 includes, for example, a water absorption portion (not shown) and a water repellent portion (not shown). The water absorption portion is, for example, located around the second openings 144 and near the first openings 132, and the water repellent portion is, for example, located around the second openings 144 and away from the first openings 132, such that the water absorption portion is disposed between the water repellent portion and at least one of the second openings 144. The water generated on the cathode layer 114 of the MEA 110 after the chemical reaction is absorbed by the water absorption portion at a position near the first openings 132, and is drained out of the capillary material 142 by the water repellent portion due to the gravity action. Therefore, the water will not be accumulated at the first openings 132, and thus the oxygen gas may pass through the first openings 132 smoothly, and be transported to the cathode catalyst layer without the obstruction of the water.

The length of the shortest side of the aperture of the first openings 132 is, for example, the same as the length of the shortest side of the aperture of the second openings 144. For example, the first openings 132 and the second openings 144 are round holes having the same aperture. Or alternatively, one of the first openings 132 and the second openings 144 are oblong holes, and the other one of the first openings 132 and the second openings 144 are round holes. The length of the shortest side of the aperture of the oblong holes is the same as the aperture of the round holes.

In addition, the fuel cell 100a may further include a water tank 150 disposed under the MEA 110, and the water generated on the cathode layer 114 of the MEA 110 after the chemical reaction is suitable for being transported to the water tank 150 through the water transport layer 140. In this embodiment, the water generated on the cathode layer 114 drops into the water tank 150 by the capillary material 142 due to, for example, the gravity action. It should be noted that, when the fuel of the fuel cell 100a is methanol, the reactants of the anode layer 112 must include methanol and water. Therefore, the water in the water tank 150 may be further transported to the anode layer 112 to be used again. Additionally, the fuel cell 100a may further include a fan 160 disposed near the cathode layer 114 of the MEA 110 to provide the oxygen gas required by the cathode layer 114 in the chemical reaction.

### The Second Embodiment

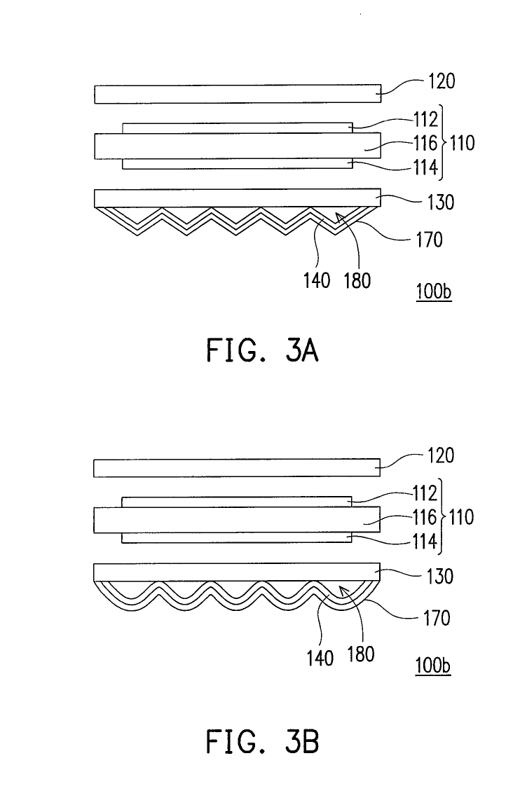

Referring to FIGS. 3A and 3B, the structure of the fuel cell 100b in the second embodiment of the present invention is substantially the same as the fuel cell 100a in FIGS. 1 and 2 except for the fuel cell 100b further includes a cathode flow field plate 170. The cathode flow field plate 170 is, for example, in contact with the cathode current collector 130, and is disposed on a side of the cathode current collector 130 not facing the MEA 110, and the water transport layer 140 is, for example, disposed on the cathode flow field plate 170, and between the cathode current collector 130 and the cathode flow field plate 170.

Likewise, the water transport layer 140 includes, for example, a capillary material (not shown) and a plurality of second openings (not shown) corresponding to the first openings (not shown) of the cathode current collector 130. As the shape of the section of the cathode flow field plate 170 is, for example, jagged (as shown in FIG. 3A) or corrugated (as shown in FIG. 3B), such that a plurality of flow fields 180 is formed between the cathode current collector 130 and the cathode flow field plate 170.

The water generated on the cathode layer 114 of the MEA 110 after the chemical reaction may be absorbed by the water transport layer 140 at the position where the cathode current collector 130 contacts with the cathode flow field plate 170. Then, the water absorbed by the water transport layer 140 is drained out of the water transport layer 140 along the flow fields 180 due to the gravity.

Likewise, the fuel cell 100b may also include at least one of a water tank 150 and a fan 160. The arrangement and functions of the water tank 150 and the fan 160 are the same as those of the first embodiment, and will not be repeated here.

### The Third Embodiment

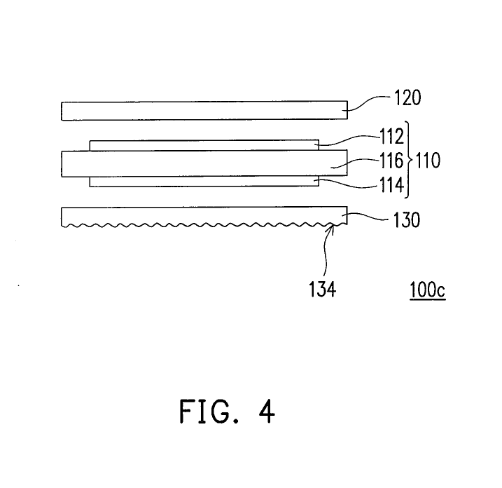

Referring to FIG. 4, the fuel cell 100c of the third embodiment of the present invention is substantially the same as the fuel cell 100a in FIGS. 1 and 2 except for the structure of the cathode current collector 130. In this embodiment, the surface of the cathode current collector 130 further has a water transport micro flow field 134, and the water generated on the cathode layer 114 of the MEA 110 after the chemical reaction is, for example, accumulated on the water transport micro flow field 134 in the surface of the cathode current collector 130. Thereafter, the water accumulated in the water transport micro flow field 134 is drained out of the surface of the cathode current collector 130 along the water transport micro flow field 134 due to the gravity.

The cathode current collector 130 includes, for example, the capillary material 142 (shown in FIGS. 1 and 2) of the first embodiment, and the water transport micro flow field 134 is, for example, formed on the surface of the capillary material 142. In addition, the cathode current collector 130 has a plurality of first openings 132 (shown in FIGS. 1 and 2), and the water transport micro flow field 134 may also have a plurality of second openings 144 (as shown in FIGS. 1 and 2) corresponding to the first openings 132. The structures and functions of the first openings 132 and the second openings 144 are the same as those in the first embodiment, and will not be repeated here.

In addition, the fuel cell 100c may also include at least one of the water transport layer 140, the water tank 150, and the fan 160. The arrangement and functions of the water transport layer 140, the water tank 150, and the fan 160 are the same as those in the first embodiment, and will not be repeated here.

To sum up, since the fuel cell of the present invention removes the water generated on the cathode layer of the MEA after the chemical reaction through the capillarity and the gravity, the water generated on the cathode layer will not be accumulated on the cathode layer to prevent the cathode catalyst layer from contacting with the oxygen gas. Furthermore, in the present invention, the water generated on the cathode layer may be removed without consuming additional energy, so the power generating efficiency is high.

Furthermore, compared with the conventional fuel cell, in the present invention, the water generated on the cathode layer may be removed without increasing the rotational speed of the fan, so the fuel cell may maintain a preferable temperature, so as to maintain the power generating efficiency. In addition, when the fuel used in the present invention is methanol, the reactant of the anode layer must include methanol and water. Therefore, the water tank may be used to collect the water generated on the cathode layer, and then, the water accumulated in the water tank may be transported to the anode layer to be used again.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell, comprising:
a membrane electrode assembly, comprising a cathode layer, an anode layer and an electrolyte layer disposed between the cathode layer and the anode layer;
an anode current collector, contacting with the anode layer;
a cathode current collector, contacting with the cathode layer, wherein the membrane electrode assembly is disposed between the anode current collector and the cathode current collector, and wherein the cathode current collector has a plurality of first openings; and
a water transport layer, attached on the cathode current collector, wherein the water transport layer comprises a capillary material and a plurality of second openings corresponding to the first openings of the cathode current collector.

2. The fuel cell as claimed in claim 1, wherein the electrolyte layer comprises a proton exchange membrane.

3. The fuel cell as claimed in claim 1, further comprising a water tank disposed under the membrane electrode assembly, wherein water generated on the cathode layer of the membrane electrode assembly is transported to the water tank through the water transport layer.

4. The fuel cell as claimed in claim 1, wherein the capillary material is paper, gauze, cotton cloth, or a fiber material.

5. The fuel cell as claimed in claim 1, wherein a length of a shortest side of an aperture of the first openings is the same as a length of a shortest side of an aperture of the second openings.

6. The fuel cell as claimed in claim 1, wherein the water transport layer comprises a water absorption portion and a water repellent portion, the water absorption portion and the water repellent portion are located around the second openings, and the water absorption portion is disposed between the water repellent portion and at least one of the second openings.

7. The fuel cell as claimed in claim 1, wherein the water transport layer and the cathode current collector are fixed by means of adhesion, riveting, and compression.

8. The fuel cell as claimed in claim 1, further comprising a fan disposed adjacent to the cathode layer of the membrane electrode assembly.

9. A fuel cell, comprising:
a membrane electrode assembly, comprising a cathode layer, an anode layer and an electrolyte layer disposed between the cathode layer and the anode layer;
an anode current collector, contacting with the anode layer;
a cathode current collector, contacting with the cathode layer, wherein the cathode current collector has a plurality of first openings;
a cathode flow field plate, contacting with the cathode current collector, and disposed on a side of the cathode current collector not facing the membrane electrode assembly; and
a water transport layer, attached on the cathode flow field plate, wherein the water transport layer comprises a capillary material.

10. The fuel cell as claimed in claim 9, wherein the water transport layer comprises a plurality of second openings corresponding to the first openings of the cathode current collector.

11. The fuel cell as claimed in claim 9, further comprising a water tank disposed under the membrane electrode assembly.

12. The fuel cell as claimed in claim 9, wherein the water transport layer is disposed between the cathode current collector and the cathode flow field plate.

13. The fuel cell as claimed in claim 9, wherein a plurality of flow fields is formed between the cathode current collector and the cathode flow field plate.

14. The fuel cell as claimed in claim 13, wherein a shape of a section of the cathode flow field plate is jagged or corrugated.

15. A fuel cell, comprising:
a membrane electrode assembly, comprising a cathode layer, an anode layer and an electrolyte layer disposed between the cathode layer and the anode layer;
an anode current collector, contacting with the anode layer; and
a cathode current collector, contacting with the cathode layer, wherein the cathode current collector has a plurality of first openings and a water transport micro flow field.

16. The fuel cell as claimed in claim 15, wherein the cathode current collector comprises a capillary material, and the water transport micro flow field is formed on the capillary material.

17. The fuel cell as claimed in claim 15, wherein the water transport micro flow field has a plurality of second openings corresponding to the first openings.
